(19) United States
(12) Patent Application Publication
(10) Pub. No.: US 2024/0378759 A1
(43) Pub. Date: Nov. 14, 2024

(54) DECOMPRESSION OF COMPRESSED TEXTURE SETS

(71) Applicant: NVIDIA Corporation, Santa Clara, CA (US)

(72) Inventors: Karthik Vaidyanathan, Oakland, CA (US); Marco Salvi, Seattle, WA (US); Bartlomiej Wronski, Brooklyn, NY (US); Tomas Akenine-Moller, Lund (SE); Johan Pontus Ebelin, LUND (SE); Aaron Eliot Lefohn, Kirkland, WA (US); John Matthew Burgess, Austin, TX (US); Steven James Heinrich, Madison, AL (US); Michael Alan Fetterman, Lancaster, MA (US); Shirish Gadre, Fremont, CA (US); Mark Alan Gebhart, Round Rock, TX (US); Yury Uralsky, Los Gatos, CA (US)

(21) Appl. No.: 18/661,421

(22) Filed: May 10, 2024

Related U.S. Application Data
(60) Provisional application No. 63/466,206, filed on May 12, 2023.

(51) Int. Cl. G06T 9/00; G06T 15/00

(52) U.S. Cl. CPC G06T 9/00; G06T 15/005

(57) ABSTRACT

In computer graphics, texture refers to a type of surface, including the material characteristics, that can be applied to an object in an image. A texture may be defined using numerous parameters, such as color(s), roughness, glossiness, etc. In some implementations, a texture may be represented as an image that can be placed on a three-dimensional (3D) model of an object to give surface details to the 3D object. To reduce a size of textures (e.g. for storage and transmission), textures in a texture set may be compressed together. The present disclosure provides for decompression of at least a portion of a single texture representation of a set of textures into at least a portion of a plurality of textures included in the set of textures.

### CLAIM OF PRIORITY

This application claims the benefit of U.S. Provisional Application No. 63/466,206 (Attorney Docket No. NVIDP1377+/23-RE-0071US02) titled “RANDOM-ACCESS NEURAL COMPRESSION OF MATERIAL TEXTURES,” filed May 12, 2023, the entire contents of which is incorporated herein by reference.

### TECHNICAL FIELD

The present disclosure relates to texture decompression for computer graphics.

### BACKGROUND

In computer graphics, texture refers to a type of surface, including the material characteristics, that can be applied to an object in an image. A texture may be defined using numerous parameters, such as color(s), roughness, glossiness, etc. In some implementations, a texture may be represented as an image that can be placed on a three-dimensional (3D) model of an object to give surface details to the 3D object. Textures can accordingly be used to provide photorealism in computer graphics, but they also have certain storage, bandwidth, and memory demands. Thus, limited disk storage, download bandwidth, and memory size constraints must be addressed to continuously improve photorealism in computer graphics via more detailed and available textures.

As a solution to reduce these resource demands, textures can be compressed (i.e. reduced in size using some preconfigured compression algorithm) prior to storage and/or network transmission. However, current texture compression methods are lacking. For example, traditional block-based texture compression methods, which rely on fixed sized blocks, are designed only for moderate compression rates. Block-based compression methods are also limited in the number of material properties that can be compressed together per texture, and as a result require multiple textures to cover all the desired material properties.

Neural image compression, which has been introduced more recently for compressing textures, incorporates non-linear transformations in the form of neural networks to aid compression and decompression. Neural image compression methods require large-scale image data sets and expensive training. They are also not suitable for real-time rendering because of their lack of random access and their inability to compress non-color material properties and a high decompression cost.

There is thus a need for addressing these issues and/or other issues associated with the prior art.

### SUMMARY

A method, computer readable medium, and system are disclosed to provide decompression of a compressed texture set. At least a portion of a single texture representation of a set of textures is decompressed into at least a portion of a plurality of textures included in the set of textures. The at least a portion of the plurality of textures is output.

### BRIEF DESCRIPTION OF THE DRAWINGS

FIG. 1 illustrates a flowchart of a method for decompression of a single texture representation of a set of textures, in accordance with an embodiment.

FIG. 2 illustrates an exemplary texture set, in accordance with an embodiment.

FIG. 3 illustrates an exemplary compressed representation of a texture set as a pyramid of a plurality of feature levels which allows for decompression of only a portion thereof, in accordance with an embodiment.

FIG. 4 illustrates a flowchart of a method for decompressing a single texture representation of a set of textures for use in rendering by a processing unit, in accordance with an embodiment.

FIG. 5 illustrates a flowchart of a method for generating an interleaved texture, in accordance with an embodiment.

FIG. 6 illustrates a flowchart of a method for filtering texels fetched from an interleaved texture, in accordance with an embodiment.

FIG. 7A-7B illustrate different implementations of processing a single texture representation of a set of textures, in accordance with various embodiments.

FIG. 8A illustrates inference and/or training logic, according to at least one embodiment;

FIG. 8B illustrates inference and/or training logic, according to at least one embodiment;

FIG. 9 illustrates training and deployment of a neural network, according to at least one embodiment;

FIG. 10 illustrates an example data center system, according to at least one embodiment.

### DETAILED DESCRIPTION

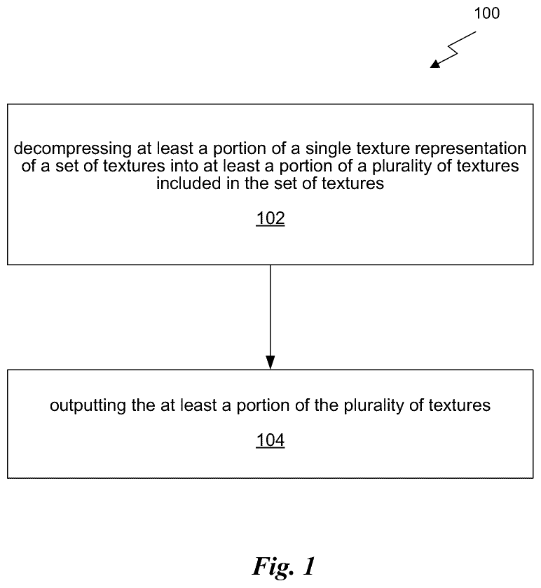

FIG. 1 illustrates a flowchart of a method 200 for decompression of a single texture representation of a set of textures, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, at least a portion of a single texture representation of a set of textures is decompressed into at least a portion of a plurality of textures included in the set of textures. With respect to the present description, a texture refers to a data representation of at least one property of an object surface. The data representation may be in two-dimensions (2D), three-dimensions (3D) [e.g. 2D with also a time dimension, or volumetric], four-dimensions (4D) [e.g. volumetric with also a time dimension), or in other embodiments even a greater number of dimensions. The property (ies) may be of a physical material (e.g. metal, wood, ceramic, glass, etc.), in an embodiment. In various examples, each property may indicate ambient occlusion, roughness, metalness, diffuse color, normals maps, height maps, glossiness, other Bidirectional Reflectance Distribution Function (BRDF) information, subsurface scattering properties, anisotropy, transmittance, etc.

In an embodiment, the texture may be represented as an image. The texture can be applied to a surface of an object (e.g. in an image) to give surface details to the object. The object may be a 2D object or a 3D object.

As mentioned, the present operation 102 relates to decompressing a single texture representation of a set of textures. In an embodiment, the set of textures may include a plurality of textures. In an embodiment, the set of textures (or “texture set”) may represent a (particular) material. For example, each texture in the texture set may represent a different property of the material. In an embodiment, the textures in the texture set may be layered or otherwise combined to represent a specific material, such that when applied to an object the surface of the object appears to be of the material.

In an embodiment, at least one texture in the texture set may include a plurality of channels. In this embodiment, each channel of the texture may store data for a different property of the object surface. Thus, as noted above, each texture may store one or more properties of the object surface. Of course, in other embodiments, at least one texture in the texture set may include a single channel.

The single texture representation refers to a single data structure that has been generated to represent the set of textures. In an embodiment, the single texture representation may be a compressed representation of a plurality of textures included in the set of textures. The compressed representation may be smaller in size (memory-wise) than the original texture set.

In an embodiment, the compressed representation may be generated by exploiting correlations (e.g. redundancies) across the plurality of textures in the texture set and/or across a plurality of channels of the plurality of textures in the texture set. In embodiments, the compressed representation may be generated by exploiting correlations spatially across each texture in the set of textures and/or across mip levels. In general, exploiting correlations refers to at least partially reducing the correlated (e.g. redundant) data during compression.

In an embodiment, the compressed representation may be generated using at least one compression method. In another embodiment, the compressed representation may be generated using at least two compression methods. In an embodiment, the single texture representation may be learned using a neural network. In another embodiment, the single texture representation may be further generated by applying an entropy encoding to an output of the neural network. One exemplary embodiment of generating a compressed representation of a plurality of textures included in a set of textures is disclosed in U.S. application Ser. No. 18/420,625, filed Jan. 23, 2024 and entitled “COMPRESSION OF TEXTURE SETS USING A NON-LINEAR FUNCTION AND QUANTIZATION,” which is hereby incorporated by reference in its entirety.

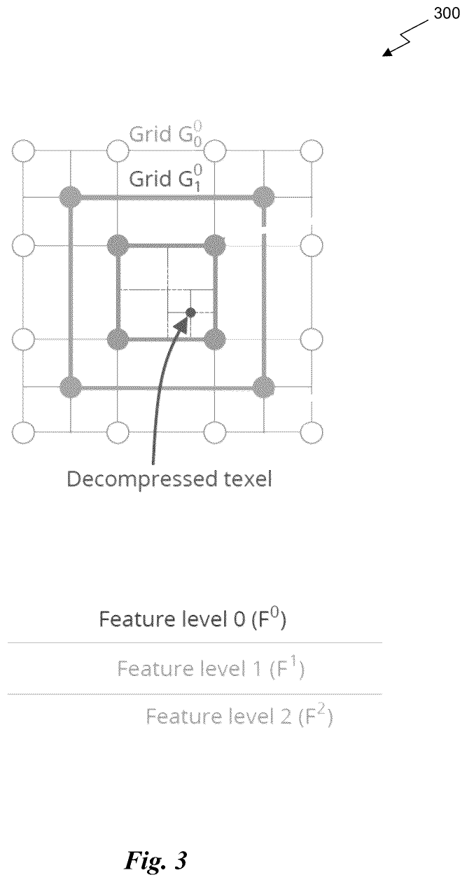

In an embodiment, the single texture representation may be a pyramid of a plurality of feature levels, where each feature level of the plurality of feature levels includes a plurality of grids, which may be in 2D, 3D, etc. corresponding to the dimensions of the original textures. In an embodiment, the grids may store data that can be used during the decompression of operation 102 to unpack at least a portion of an image or texture. An embodiment of the pyramid structure of the single texture representation will be described in more detail below with reference to FIG. 3.

Returning to operation 102, at least a portion of the single texture representation is decompressed into at least a portion of a plurality of textures included in the set of textures. In other words, at least a portion of the textures included in the texture set are decompressed (or unpacked) from the single texture representation. In an embodiment, the single texture representation, such as in the pyramid format mentioned above, may enable random access such that only a portion (i.e. less than an entirety) of the single texture representation is decompressed. In some embodiments, this portion may be a texel or other rectangular part of a 2D texture set or may be a 3D box within a 3D texture set.

In an embodiment, the decompressing may be performed in hardware. For example, the decompressing may be performed in a processing unit driver, such as a driver of a graphics processing unit (GPU). In another embodiment, the decompressing may be performed in system software.

In an embodiment, the decompressing may be performed at load time when loading graphics data to memory for use by a processing unit during rendering. In an embodiment, the decompressing may be performed at install time when an application has been downloaded and installed onto a storage device of a computer. In an embodiment, the at least a portion of the single texture representation may be streamed to a memory for decompression. In an embodiment, such streaming may occur while a portion of the plurality of textures is being rendered.

In operation 104, the at least a portion of the plurality of textures is output. In an embodiment, the at least a portion of the plurality of textures that has been decompressed may be output to storage. The storage may be memory local to the device that performed the decompression or memory remote from the device that performed the decompression. In an embodiment, the result may be output to a remote computing device (e.g. over a network) for use in rendering an image. For example, the remote computing device may be configured to apply the decompressed portion of textures to an object in an image when rendering the image. Of course, in another embodiment, the device that performed the decompression may access the at least a portion of the plurality of textures that has been decompressed from local or remote storage to likewise use the same to render an image.

In an embodiment, the at least a portion of the plurality of textures that has been decompressed may be output to a downstream task configured to process the at least a portion of the plurality of textures. In an embodiment, the at least a portion of the plurality of textures may be output for rendering thereof. In an embodiment, the decompression may be performed in real-time.

In an embodiment, the at least a portion of the plurality of textures may be output for further processing. For example, the output at least a portion of the plurality of textures may be compressed into a select (e.g. defined) compressed format, which may be a select block compression format. BC1-BC7 are exemplary block compression formats, while other block compression formats, may include ETC, ETC2, ASTC, etc. In an embodiment, the select compressed format may be one that is supported by a processing unit that performs rendering.

As another example, the output at least a portion of the plurality of textures may be interleaved to form at least one interleaved texture. In an embodiment, the output at least a portion of the plurality of textures may be compressed into at least one select compressed format to form two or more compressed textures, and the interleaving may be applied to the two or more compressed textures to form the at least one interleaved texture. In an embodiment, compressing the output at least a portion of the plurality of textures may include compressing a first output portion into a first select compressed format to form a first compressed texture and compressing a second output portion into a second select compressed format to form a second compressed texture, where the interleaving is applied to the first compressed texture and the second compressed texture.

In an embodiment, a special-purpose hardware may access the at least one interleaved texture. In an embodiment, the special-purpose hardware may access the at least one interleaved texture for filtering. In an embodiment, the filtering may be stochastic texture filtering. In an embodiment, the filtering may be performed by shader code. In an embodiment, the shader code may compute which texel locations to access and may then send the locations to a special purpose hardware unit for use in fetching the texels. In another embodiment, the shader code may compute which texel locations to access, ask a texture unit to fetch texels for the computed locations, and then filter the fetched texels.

### Exemplary Use Case

Virtual texture streaming/tiled resources: Each texture and each mip level is split into multiple “tiles” (e.g. where size depends on hardware and an application programming interface (API)). A shader program is modified so that it can ask the texturing unit whether a tile is resident for a needed mip level. If the tile is not resident, the shader program writes the value into a separate buffer indicating that a specific tile and a portion of the texture is needed. With the present method 100 of FIG. 1, on-demand decompression of the needed tile and portion of texture can occur on the GPU or in the driver.

Further embodiments will now be provided in the description of the subsequent figures. It should be noted that the embodiments disclosed herein with reference to the method 100 of FIG. 1 may apply to and/or be used in combination with any of the embodiments of the remaining figures below.

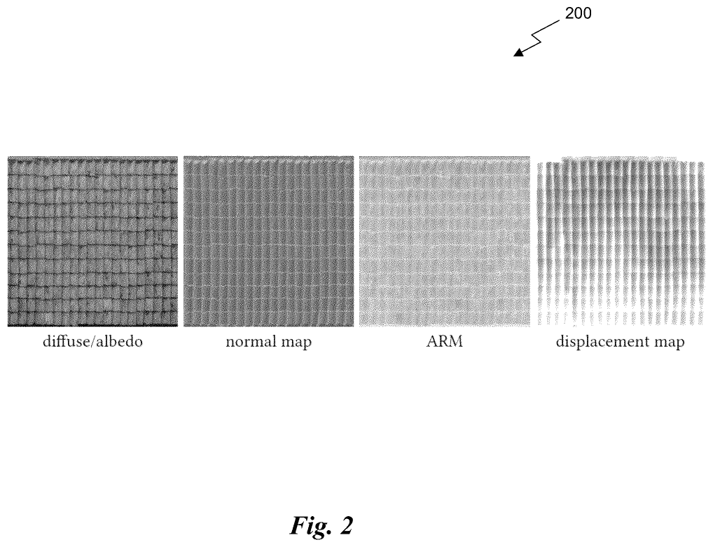

FIG. 2 illustrates an exemplary texture set 200, in accordance with an embodiment. It should be noted that the texture set 200 shown and described is set forth for illustrative purposes only. The present disclosure is applicable to texture sets that have any combination and number of different textures (e.g. representing different materials).

In the example shown, the texture set includes four different textures, consisting of a diffuse map, a normal map, an ARM (ambient occlusion, roughness, metalness) texture, and a displacement map. The texture set represents a ceramic roof material. This exemplary texture set may be compressed to form a single (compressed) representation of the texture set, which in turn may be decompressed in accordance with the method 100 of FIG. 1 described above.

FIG. 3 illustrates an exemplary compressed representation 300 of a texture set as a pyramid of a plurality of feature levels, in accordance with an embodiment. The compressed representation 300 shown is one embodiment of the result of a texture compression method when applied to a texture set. Furthermore, the compressed representation 300 as shown and described correlates with 2D textures, but it should be noted that the concepts described may be extended to textures with greater dimensions. This compressed representation 300 may be partially or fully decompressed into at least a portion of the textures in the texture set, in accordance with the method 100 of FIG. 1.

As mentioned, the compressed representation 300 is a pyramid of multiple feature levels Fⱼ, with each level, j, comprising a pair of 2D grids, G₀^{j} and G₁^{j}. The grids' cells store feature vectors of quantized latent values, which are utilized to predict multiple mip levels of the original texture set. In an embodiment, each feature level of the plurality of feature levels may represent a plurality of mip levels. The sharing of features across two or more mip levels lowers the storage cost of a traditional mipmap chain. Furthermore, within a feature level, grid G₀ is at a higher resolution, which helps preserve high-frequency details, while G₁ is at a lower resolution, improving the reconstruction of low-frequency content, such as color and smooth gradients. To this end, in an embodiment, a resolution of the grids may be reduced across the plurality of feature levels, from a top feature level of the pyramid to a bottom feature level of the pyramid. In an embodiment, a resolution of the grids may be less than a resolution of the plurality of textures in the texture set prior to compression.

Table 1 illustrates the exemplary feature levels and grid resolutions for a 1024×1024 texture set. The resolution of the grids is significantly lower than the texture resolution, resulting in a highly compressed representation of the entire mip chain. Typically, a feature level represents two mip levels, with some exceptions; the first feature level must represent all higher resolution mips (levels 0 to 3), and the last feature level represents the bottom three mip levels, as it cannot be further downsampled.

TABLE 1

| Feature level | G₀^{j} grid | G₁^{j} grid | Predicted mip |
|---|---|---|---|
| F^{j} | resolution | resolution | levels |
| 0 | 256 × 256 | 128 × 128 | 0, 1, 2, 3 |
| 1 | 64 × 64 | 32 × 32 | 4, 5 |
| 2 | 16 × 16 | 8 × 8 | 6, 7 |
| 3 | 4 × 4 | 2 × 2 | 8, 9, 10 |

In an embodiment, the 2D grids may store data that can be used during the texture decompression of the method 100 of FIG. 1, and in particular that can be used to unpack at least a portion of an image or texture.

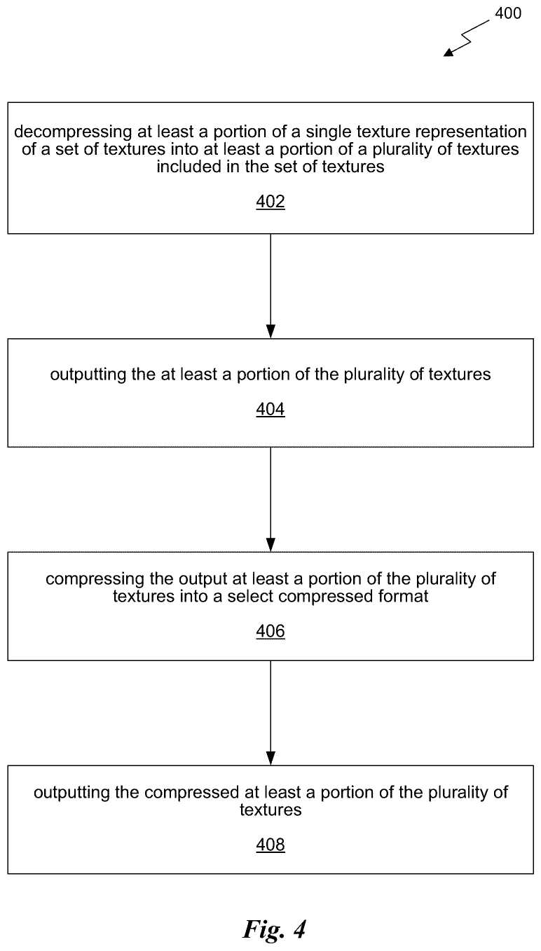

FIG. 4 illustrates a flowchart of a method 400 for decompressing a single texture representation of a set of textures for use in rendering by a processing unit, in accordance with an embodiment. As described herein, the method 400 may be carried out as an extension to the method 100 of FIG. 1. It should be noted that the definitions and descriptions provided above may apply to the present method 400.

In operation 402, at least a portion of a single texture representation of a set of textures is decompressed into at least a portion of a plurality of textures included in the set of textures. This may be performed according to operation 102 of FIG. 1. In operation 404, the at least a portion of the plurality of textures is output. This may be performed according to operation 104 of FIG. 1.

Subsequently in operation 406, the output at least a portion of the plurality of textures is compressed into a select compressed format. In an embodiment, the select compressed format may be a BC format. For example, the output may be compressed in the BC format using a traditional BCx compressor. In an embodiment, the select compressed format may be one that is supported by a processing unit (described below).

In operation 408, the compressed at least a portion of the plurality of textures is output. In an embodiment, the compressed at least a portion of the plurality of textures may be output to a storage, for example to be accessed by a processing unit. In an embodiment, the compressed at least a portion of the plurality of textures may be output directly to the processing unit. In any case, the processing unit is configured to decompress the portion(s) of textures in the select compressed format and to then render the decompressed portion(s) of textures.

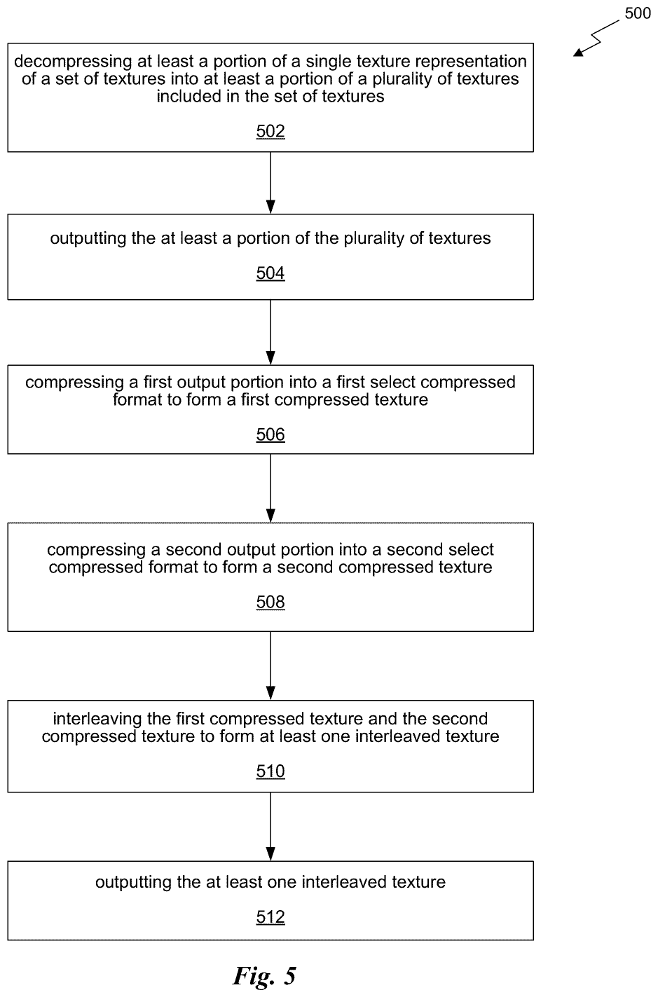

FIG. 5 illustrates a flowchart of a method 500 for generating an interleaved texture, in accordance with an embodiment. As described herein, the method 500 may be carried out as an extension to the method 100 of FIG. 1. It should be noted that the definitions and descriptions provided above may apply to the present method 500.

In operation 502, at least a portion of a single texture representation of a set of textures is decompressed into at least a portion of a plurality of textures included in the set of textures. This may be performed according to operation 102 of FIG. 1. In operation 504, the at least a portion of the plurality of textures is output. This may be performed according to operation 104 of FIG. 1.

Further, in operation 506, a first output portion is compressed into a first select compressed format to form a first compressed texture. The first output portion refers to a first select portion of the output from operation 504. In operation 508, a second output portion is compressed into a second select compressed format to form a second compressed texture. The second output portion refers to a second select portion of the output from operation 504. In the present embodiment, the first select portion and the second select portion are different portions (e.g. subparts) of the decompressed portion(s) of the single texture representation output from operation 504. For example, the first and second select portions may be the same 2D rectangle or 3D box of pixels, but they will represent different layers or channels in the texture set.

In an embodiment, the first select compressed format and the second select compressed format are different. For example, the first select compressed format and the second select compressed format may correspond to different compression algorithms. In this way, the different compression algorithms may be used to generate the first compressed texture and the second compressed texture.

In operation 510, the first compressed texture and the second compressed texture are interleaved to form at least one interleaved texture. Interleaving refers to alternating portions (e.g. blocks) from the first and second compressed textures. One example of interleaving textures is disclosed in U.S. Pat. No. 11,823,318, filed Jun. 4, 2021 and entitled “Techniques for interleaving textures,” which is hereby incorporated by reference in its entirety.

In operation 512, the at least one interleaved texture is output. For example, the at least one interleaved texture may be output to a storage, for example to be accessed by a processing unit. In an embodiment, the at least one interleaved texture may be output directly to the processing unit. In any case, the processing unit is configured to access one or more select portions of the at least one interleaved texture, decompress the accessed portion(s), and then render the decompressed portion(s). By interleaving the textures as described above, incoherent accesses may become faster when different textures are accessed. It should be noted that while only two compressed textures are described herein as being interleaved, other embodiments are contemplated in which more than two compressed textures having different compressed formats may be interleaved into one or more interleaved textures.

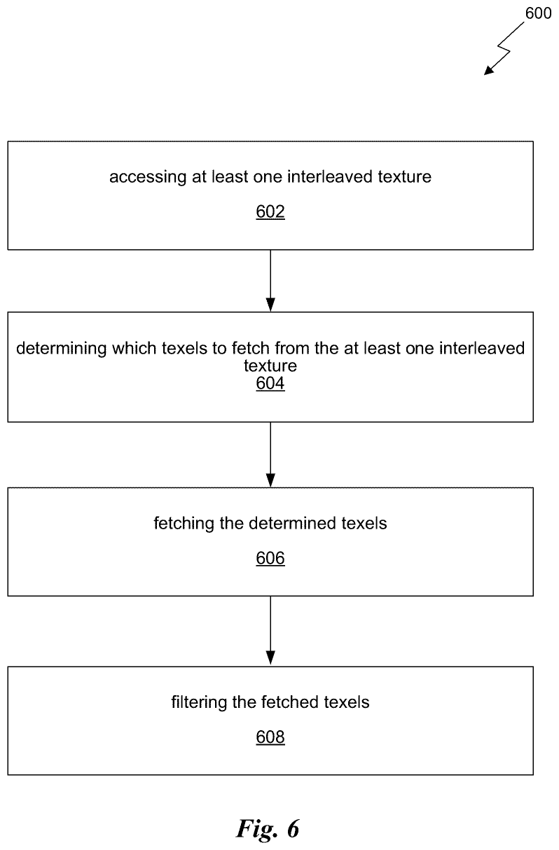

FIG. 6 illustrates a flowchart of a method 600 for filtering texels fetched from an interleaved texture, in accordance with an embodiment. As described herein, the method 500 may be carried out as an extension to the method 500 of FIG. 5. It should be noted that the definitions and descriptions provided above may apply to the present method 500.

In operation 602, at least one interleaved texture is accessed. The at least one interleaved texture may refer to the at least one interleaved texture generated via the method 500 of FIG. 5. In an embodiment, the at least one interleaved texture may be accessed from a storage.

In operation 604, it is determined which texels to fetch from the at least one interleaved texture. In an embodiment, the number of textures that are interleaved and their compressed (for example BCx) formats may determine where the texels to be accessed are located. The determination of which texels to fetch may be based on one or more portions of one or more texture(s) to be rendered. In operation 606, the determined texels are fetched from the at least one interleaved texture. In operation 608, the fetched texels are filtered. In an embodiment, a standard hardware texture filtering method may be used. In another embodiment, the filtering may be stochastic texture filtering. Details on stochastic filtering are disclosed in Fajardo, Marcos & Wronski, Bartlomiej & Salvi, Marco & Pharr, Matt, (2023), Stochastic Texture Filtering [arXiv: 2305.05810v2 [cs.GR]].

### Implementation by Special-Purpose Hardware

In an embodiment, the method 600 may be performed by special-purpose hardware. The special-purpose hardware may be configured to access the at least one interleaved texture for filtering. In particular, the special-purpose hardware may perform the filtering.

### Implementation by Shader Code

In an embodiment, the method 600 may be performed by shader code (i.e. implemented in system software). The shader code may identify an interleaved texture to access. Given the layout of this interleaved texture, the shader code can compute the locations of the texels to access. Then the shader code asks a texture unit to fetch the appropriate texels (for the locations just computed). Further, the shader code may filter the fetched texels. When filtering is done by shader code, then stochastic texture filtering may be the most appropriate method, although shader code can also do standard texture filtering, such as bilinear, trilinear, etc.

### Implementation by a Combination of Special-Purpose Hardware and Shader Code

In an embodiment, the method 600 may be performed by a combination of special-purpose hardware and shader code. The shader code computes which texel locations to access and sends these locations to a special purpose hardware unit. The special-purpose hardware may then fetch the texels determined by the shader code and then may filter the fetched texels.

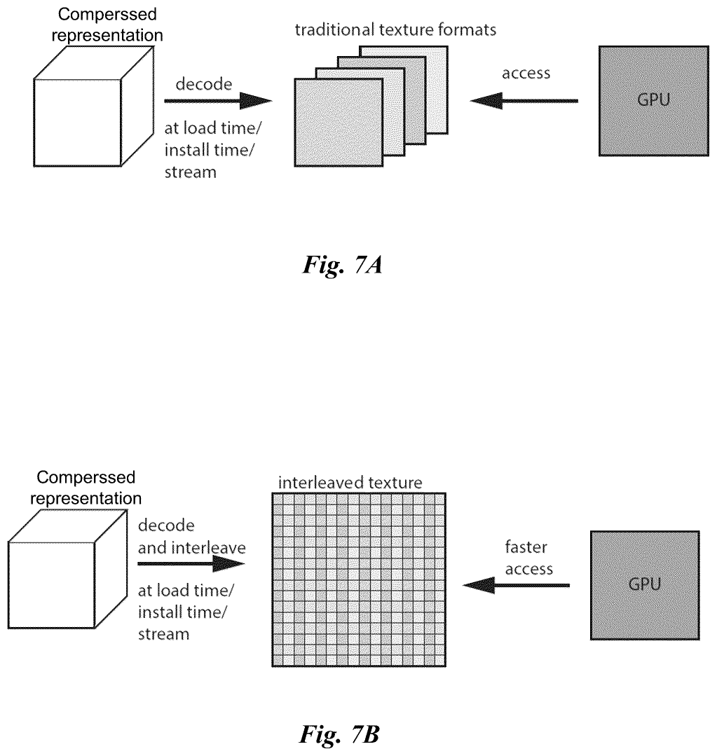

FIG. 7A-7B illustrate different implementations of processing a single texture representation of a set of textures, in accordance with various embodiments.

In FIG. 7A, a single texture representation of a set of textures is decompressed (decoded) into a plurality of textures included in the set of textures. The single texture representation may be streamed for decompression (as needed), or decompressed at install time or load time. The single texture representation is decompressed into the plurality of textures with traditional texture formats. A GPU then accesses the non-compressed textures for rendering.

In FIG. 7B, a single texture representation of a set of textures is decompressed (decoded) into a plurality of textures included in the set of textures which are then interleaved. The single texture representation may be streamed for decompression (as needed), or decompressed at install time or load time. The decompressed textures may be individually compressed prior to being interleaved. A GPU then accesses the select parts of the interleaved texture.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

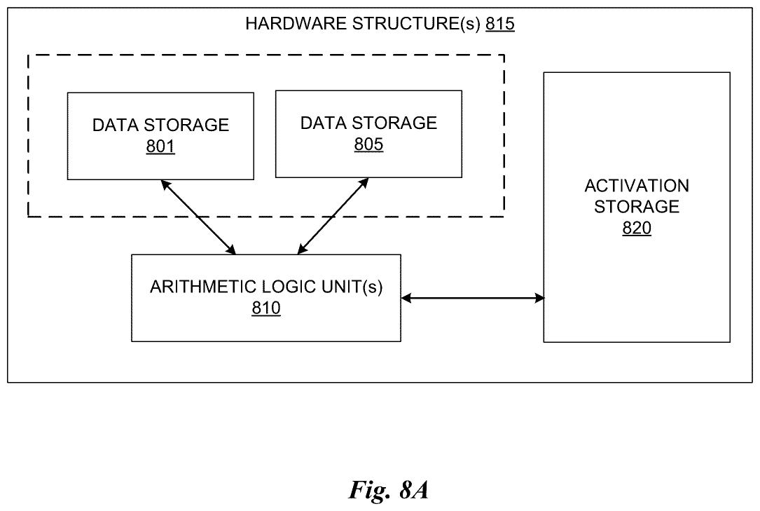

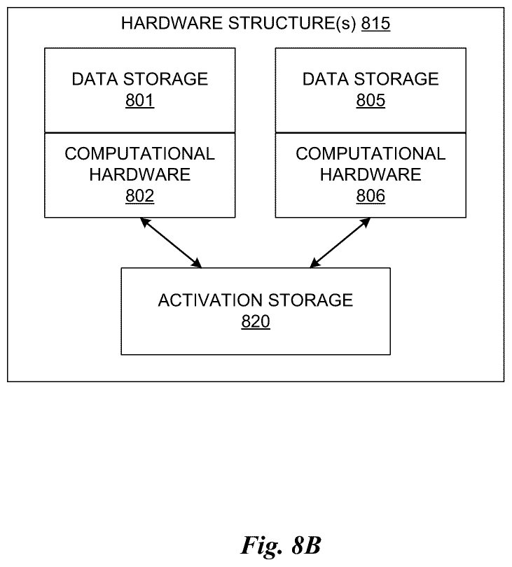

As noted above, a deep learning or neural learning system needs to be trained to generate inferences from input data. Details regarding inference and/or training logic 815 for a deep learning or neural learning system are provided below in conjunction with FIGS. 8A and/or 8B.

In at least one embodiment, inference and/or training logic 815 may include, without limitation, a data storage 801 to store forward and/or output weight and/or input/output data corresponding to neurons or layers of a neural network trained and/or used for inferencing in aspects of one or more embodiments. In at least one embodiment data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 801 may be included with other on-chip or off-chip data storage, including a processor's L1, L2, or L3 cache or system memory.

In at least one embodiment, any portion of data storage 801 may be internal or external to one or more processors or other hardware logic devices or circuits. In at least one embodiment, data storage 801 may be cache memory, dynamic randomly addressable memory (“DRAM”), static randomly addressable memory (“SRAM”), non-volatile memory (e.g., Flash memory), or other storage. In at least one embodiment, choice of whether data storage 801 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 may include, without limitation, a data storage 805 to store backward and/or output weight and/or input/output data corresponding to neurons or layers of a neural network trained and/or used for inferencing in aspects of one or more embodiments. In at least one embodiment, data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 805 may be included with other on-chip or off-chip data storage, including a processor's L1, L2, or L3 cache or system memory. In at least one embodiment, any portion of data storage 805 may be internal or external to on one or more processors or other hardware logic devices or circuits. In at least one embodiment, data storage 805 may be cache memory, DRAM, SRAM, non-volatile memory (e.g., Flash memory), or other storage. In at least one embodiment, choice of whether data storage 805 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 801 and data storage 805 may be separate storage structures. In at least one embodiment, data storage 801 and data storage 805 may be same storage structure. In at least one embodiment, data storage 801 and data storage 805 may be partially same storage structure and partially separate storage structures. In at least one embodiment, any portion of data storage 801 and data storage 805 may be included with other on-chip or off-chip data storage, including a processor's L1, L2, or L3 cache or system memory.

In at least one embodiment, inference and/or training logic 815 may include, without limitation, one or more arithmetic logic unit(s) (“ALU(s)”) 810 to perform logical and/or mathematical operations based, at least in part on, or indicated by, training and/or inference code, result of which may result in activations (e.g., output values from layers or neurons within a neural network) stored in an activation storage 820 that are functions of input/output and/or weight parameter data stored in data storage 801 and/or data storage 805. In at least one embodiment, activations stored in activation storage 820 are generated according to linear algebraic and or matrix-based mathematics performed by ALU(s) 810 in response to performing instructions or other code, wherein weight values stored in data storage 805 and/or data 801 are used as operands along with other values, such as bias values, gradient information, momentum values, or other parameters or hyperparameters, any or all of which may be stored in data storage 805 or data storage 801 or another storage on or off-chip. In at least one embodiment, ALU(s) 810 are included within one or more processors or other hardware logic devices or circuits, whereas in another embodiment, ALU(s) 810 may be external to a processor or other hardware logic device or circuit that uses them (e.g., a co-processor). In at least one embodiment, ALUs 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 801, data storage 805, and activation storage 820 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., Flash memory), or other storage. In at least one embodiment, activation storage 820 may be completely or partially within or external to one or more processors or other logical circuits. In at least one embodiment, choice of whether activation storage 820 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 815 illustrated in FIG. 8A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8A may be used in conjunction with central processing unit (“CPU”) hardware, graphics processing unit (“GPU”) hardware or other hardware, such as field programmable gate arrays (“FPGAs”).

FIG. 8B illustrates inference and/or training logic 815, according to at least one embodiment. In at least one embodiment, inference and/or training logic 815 may include, without limitation, hardware logic in which computational resources are dedicated or otherwise exclusively used in conjunction with weight values or other information corresponding to one or more layers of neurons within a neural network. In at least one embodiment, inference and/or training logic 815 illustrated in FIG. 8B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8B may be used in conjunction with central processing unit (CPU) hardware, graphics processing unit (GPU) hardware or other hardware, such as field programmable gate arrays (FPGAs). In at least one embodiment, inference and/or training logic 815 includes, without limitation, data storage 801 and data storage 805, which may be used to store weight values and/or other information, including bias values, gradient information, momentum values, and/or other parameter or hyperparameter information. In at least one embodiment illustrated in FIG. 8B, each of data storage 801 and data storage 805 is associated with a dedicated computational resource, such as computational hardware 802 and computational hardware 806, respectively. In at least one embodiment, each of computational hardware 806 comprises one or more ALUs that perform mathematical functions, such as linear algebraic functions, only on information stored in data storage 801 and data storage 805, respectively, result of which is stored in activation storage 820.

In at least one embodiment, each of data storage 801 and 805 and corresponding computational hardware 802 and 806, respectively, correspond to different layers of a neural network, such that resulting activation from one “storage/computational pair 801/802” of data storage 801 and computational hardware 802 is provided as an input to next “storage/computational pair 805/806” of data storage 805 and computational hardware 806, in order to mirror conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage computation pairs 801/802 and 805/806 may be included in inference and/or training logic 815.

### Neural Network Training and Deployment

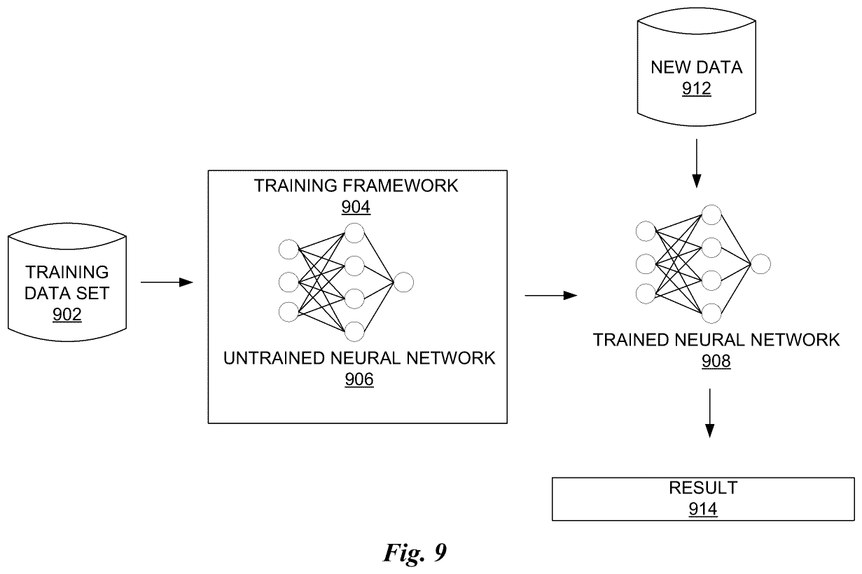

FIG. 9 illustrates another embodiment for training and deployment of a deep neural network. In at least one embodiment, untrained neural network 906 is trained using a training dataset 902. In at least one embodiment, training framework 904 is a PyTorch framework, whereas in other embodiments, training framework 904 is a Tensorflow, Boost, Caffe, Microsoft Cognitive Toolkit/CNTK, MXNet, Chainer, Keras, Deeplearning4j, or other training framework. In at least one embodiment training framework 904 trains an untrained neural network 906 and enables it to be trained using processing resources described herein to generate a trained neural network 908. In at least one embodiment, weights may be chosen randomly or by pre-training using a deep belief network. In at least one embodiment, training may be performed in either a supervised, partially supervised, or unsupervised manner.

In at least one embodiment, untrained neural network 906 is trained using supervised learning, wherein training dataset 902 includes an input paired with a desired output for an input, or where training dataset 902 includes input having known output and the output of the neural network is manually graded. In at least one embodiment, untrained neural network 906 is trained in a supervised manner processes inputs from training dataset 902 and compares resulting outputs against a set of expected or desired outputs. In at least one embodiment, errors are then propagated back through untrained neural network 906. In at least one embodiment, training framework 904 adjusts weights that control untrained neural network 906. In at least one embodiment, training framework 904 includes tools to monitor how well untrained neural network 906 is converging towards a model, such as trained neural network 908, suitable to generating correct answers, such as in result 914, based on known input data, such as new data 912. In at least one embodiment, training framework 904 trains untrained neural network 906 repeatedly while adjust weights to refine an output of untrained neural network 906 using a loss function and adjustment algorithm, such as stochastic gradient descent. In at least one embodiment, training framework 904 trains untrained neural network 906 until untrained neural network 906 achieves a desired accuracy. In at least one embodiment, trained neural network 908 can then be deployed to implement any number of machine learning operations.

In at least one embodiment, untrained neural network 906 is trained using unsupervised learning, wherein untrained neural network 906 attempts to train itself using unlabeled data. In at least one embodiment, unsupervised learning training dataset 902 will include input data without any associated output data or “ground truth” data. In at least one embodiment, untrained neural network 906 can learn groupings within training dataset 902 and can determine how individual inputs are related to untrained dataset 902. In at least one embodiment, unsupervised training can be used to generate a self-organizing map, which is a type of trained neural network 908 capable of performing operations useful in reducing dimensionality of new data 912. In at least one embodiment, unsupervised training can also be used to perform anomaly detection, which allows identification of data points in a new dataset 912 that deviate from normal patterns of new dataset 912.

In at least one embodiment, semi-supervised learning may be used, which is a technique in which in training dataset 902 includes a mix of labeled and unlabeled data. In at least one embodiment, training framework 904 may be used to perform incremental learning, such as through transferred learning techniques. In at least one embodiment, incremental learning enables trained neural network 908 to adapt to new data 912 without forgetting knowledge instilled within network during initial training.

### Data Center

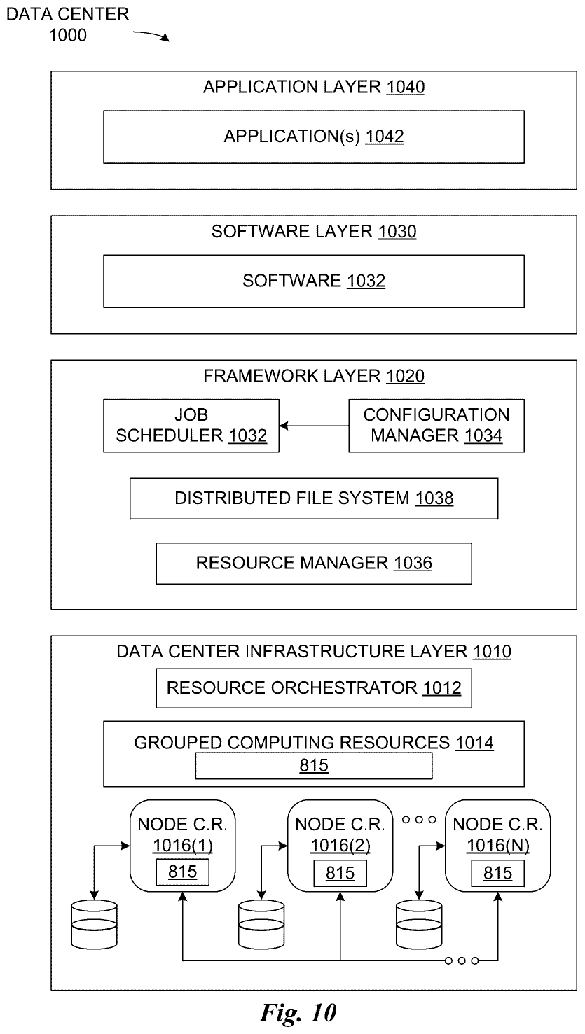

FIG. 10 illustrates an example data center 1000, in which at least one embodiment may be used. In at least one embodiment, data center 1000 includes a data center infrastructure layer 1010, a framework layer 1020, a software layer 1030 and an application layer 1040.

In at least one embodiment, as shown in FIG. 10, data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1016(1)-1016(N) may be a server having one or more of above-mentioned computing resources.

In at least one embodiment, grouped computing resources 1014 may include separate groupings of node C.R.s housed within one or more racks (not shown), or many racks housed in data centers at various geographical locations (also not shown). Separate groupings of node C.R.s within grouped computing resources 1014 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1022 may configure or otherwise control one or more node C.R.s 1016(1)-1016(N) and/or grouped computing resources 1014. In at least one embodiment, resource orchestrator 1022 may include a software design infrastructure (“SDI”) management entity for data center 1000. In at least one embodiment, resource orchestrator may include hardware, software or some combination thereof.

In at least one embodiment, as shown in FIG. 10, framework layer 1020 includes a job scheduler 1032, a configuration manager 1034, a resource manager 1036 and a distributed file system 1038. In at least one embodiment, framework layer 1020 may include a framework to support software 1032 of software layer 1030 and/or one or more application(s) 1042 of application layer 1040. In at least one embodiment, software 1032 or application(s) 1042 may respectively include web-based service software or applications, such as those provided by Amazon Web Services, Google Cloud and Microsoft Azure. In at least one embodiment, framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1032 may include a Spark driver to facilitate scheduling of workloads supported by various layers of data center 1000. In at least one embodiment, configuration manager 1034 may be capable of configuring different layers such as software layer 1030 and framework layer 1020 including Spark and distributed file system 1038 for supporting large-scale data processing. In at least one embodiment, resource manager 1036 may be capable of managing clustered or grouped computing resources mapped to or allocated for support of distributed file system 1038 and job scheduler 1032. In at least one embodiment, clustered or grouped computing resources may include grouped computing resource 1014 at data center infrastructure layer 1010. In at least one embodiment, resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. one or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016 (N), grouped computing resources 1014, and/or distributed file system 1038 of framework layer 1020. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. In at least one embodiment, self-modifying actions may relieve a data center operator of data center 1000 from making possibly bad configuration decisions and possibly avoiding underutilized and/or poor performing portions of a data center.

In at least one embodiment, data center 1000 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1000. In at least one embodiment, trained machine learning models corresponding to one or more neural networks may be used to infer or predict information using resources described above with respect to data center 1000 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 815 are used to perform inferencing and/or training operations associated with one or more embodiments. In at least one embodiment, inference and/or training logic 815 may be used in system FIG. 10 for inferencing or predicting operations based, at least in part, on weight parameters calculated using neural network training operations, neural network functions and/or architectures, or neural network use cases described herein.

As described herein, a method, computer readable medium, and system are disclosed to provide for decompression of a compressed texture set. Initially, a neural network may be used for compressing a set of textures, involving the performance of inferencing operations and for providing inferenced data. The neural network may be stored (partially or wholly) in one or both of data storage 801 and 805 in inference and/or training logic 815 as depicted in FIGS. 8A and 8B. Training and deployment of the neural network may be performed as depicted in FIG. 9 and described herein. Distribution of the neural network may be performed using one or more servers in a data center 1000 as depicted in FIG. 10 and described herein. The compressed texture set may then be decompressed in accordance with any of the embodiments disclosed with respect to FIGS. 1-7B.

What is claimed is:

1. A method, comprising:
at a device:
decompressing at least a portion of a single texture representation of a set of textures into at least a portion of a plurality of textures included in the set of textures; and
outputting the at least a portion of the plurality of textures.

2. The method of claim 1, wherein the single texture representation is a compressed representation of the plurality of textures included in the set of textures.

3. The method of claim 2, wherein the compressed representation is generated using at least one compression method.

4. The method of claim 2, wherein the compressed representation is generated using at least two compression methods.

5. The method of claim 1, wherein the single texture representation is learned using a neural network.

6. The method of claim 5, wherein the single texture representation is further generated by applying an entropy encoding to an output of the neural network.

7. The method of claim 1, wherein the single texture representation is a pyramid of a plurality of feature levels, wherein each feature level of the plurality of feature levels includes a plurality of grids.

8. The method of claim 1, wherein the set of textures represents a material.

9. The method of claim 8, wherein each texture of the plurality of textures represents a different property of the material.

10. The method of claim 1, wherein at least one texture of the plurality of textures includes a plurality of channels.

11. The method of claim 1, wherein the decompressing is performed in hardware.

12. The method of claim 11, wherein the decompressing is performed in a processing unit driver.

13. The method of claim 12, wherein the processing unit is a graphics processing unit.

14. The method of claim 1, wherein the decompressing is performed in system software.

15. The method of claim 1, wherein the decompressing is performed at load time when loading graphics data to memory for use by a processing unit during rendering.

16. The method of claim 1, wherein the decompressing is performed at install time when an application has been downloaded and installed onto a storage device of a computer.

17. The method of claim 1, wherein the at least a portion of the single texture representation is streamed to a memory for decompression.

18. The method of claim 17, wherein a portion of the single texture representation is streamed to the memory while a portion of the plurality of textures is being rendered.

19. The method of claim 1, wherein the single texture representation enables random access such that only a portion of the single texture representation is decompressed.

20. The method of claim 1, further comprising, at the device:
compressing the output at least a portion of the plurality of textures into a select compressed format.

21. The method of claim 20, wherein the select compressed format is a select block compression format.

22. The method of claim 20, wherein the select compressed format is supported by a processing unit that performs rendering.

23. The method of claim 1, further comprising, at the device:
interleaving the output at least a portion of the plurality of textures to form at least one interleaved texture.

24. The method of claim 23, further comprising, at the device:
compressing the output at least a portion of the plurality of textures into at least one select compressed format to form two or more compressed textures;
wherein the interleaving is applied to the two or more compressed textures to form the at least one interleaved texture.

25. The method of claim 24, wherein compressing the output at least a portion of the plurality of textures includes compressing a first output portion into a first select compressed format to form a first compressed texture and compressing a second output portion into a second select compressed format to form a second compressed texture, wherein the interleaving is applied to the first compressed texture and the second compressed texture.

26. The method of claim 24, wherein a special-purpose hardware accesses the at least one interleaved texture.

27. The method of claim 26, wherein the special-purpose hardware accesses the at least one interleaved texture for filtering.

28. The method of claim 27, wherein the filtering is stochastic texture filtering.

29. The method of claim 27, wherein the filtering is performed by shader code.

30. The method of claim 27, wherein shader code computes which texel locations to access and sends the locations to a special purpose hardware unit for use in fetching the texels.

31. The method of claim 24, wherein shader code computes which texel locations to access, asks a texture unit to fetch texels for the computed locations, and the fetched texels.

32. A system, comprising:
computer hardware and system software executed by the computer hardware, wherein at least one of the computer hardware or the system software is configured to:
decompress at least a portion of a single texture representation of a set of textures into at least a portion of a plurality of textures included in the set of textures; and
output the at least a portion of the plurality of textures.

33. The system of claim 32, wherein the decompressing is performed in the computer hardware.

34. The system of claim 33, wherein the decompressing is performed in a processing unit driver.

35. The system of claim 34, wherein the processing unit is a graphics processing unit.

36. The system of claim 32, wherein the decompressing is performed in the system software.

37. The system of claim 32, wherein the decompressing is performed at load time when loading graphics data to memory for use by a processing unit during rendering.

38. The system of claim 32, wherein the decompressing is performed at install time when an application has been downloaded and installed onto a storage device of the computer hardware.

39. The system of claim 32, wherein the at least a portion of the single texture representation is streamed to a memory for decompression.

40. The system of claim 39, wherein a portion of the single texture representation is streamed to the memory while a portion of the plurality of textures is being rendered.

41. The system of claim 32, wherein the single texture representation enables random access such that only a portion of the single texture representation is decompressed.

42. The system of claim 32, wherein the at least one of the computer hardware or the system software is further configured to:
compress the output at least a portion of the plurality of textures into a select compressed format.

43. The system of claim 42, wherein the select compressed format is a select block compression format.

44. The system of claim 42, wherein the select compressed format is supported by a processing unit that performs rendering.

45. The system of claim 32, wherein the at least one of the computer hardware or the system software is further configured to:
interleave the output at least a portion of the plurality of textures to form at least one interleaved texture.

46. The system of claim 45, wherein the at least one of the computer hardware or the system software is further configured to:
compress the output at least a portion of the plurality of textures into at least one select compressed format to form two or more compressed textures;
wherein the interleaving is applied to the two or more compressed textures to form the at least one interleaved texture.

47. The system of claim 46, wherein compressing the output at least a portion of the plurality of textures includes compressing a first output portion into a first select compressed format to form a first compressed texture and compressing a second output portion into a second select compressed format to form a second compressed texture, wherein the interleaving is applied to the first compressed texture and the second compressed texture.

48. The system of claim 46, wherein the system further comprises:
a special-purpose hardware configured to access the at least one interleaved texture for filtering.

49. A non-transitory computer-readable media storing computer instructions which when executed by one or more processors of a device cause the device to:
decompress at least a portion of a single texture representation of a set of textures into at least a portion of a plurality of textures included in the set of textures; and
output the at least a portion of the plurality of textures.

50. The non-transitory computer-readable media of claim 49, wherein the device is further caused to:
compress the output at least a portion of the plurality of textures into a select compressed format.

51. The non-transitory computer-readable media of claim 50, wherein the select compressed format is supported by a processing unit that performs rendering.

52. The non-transitory computer-readable media of claim 49, wherein the device is further caused to:
interleave the output at least a portion of the plurality of textures to form at least one interleaved texture.

53. The non-transitory computer-readable media of claim 52, wherein the device is further caused to:
compress the output at least a portion of the plurality of textures into at least one select compressed format to form two or more compressed textures;
wherein the interleaving is applied to the two or more compressed textures to form the at least one interleaved texture.

54. The non-transitory computer-readable media of claim 53, wherein compressing the output at least a portion of the plurality of textures includes compressing a first output portion into a first select compressed format to form a first compressed texture and compressing a second output portion into a second select compressed format to form a second compressed texture, wherein the interleaving is applied to the first compressed texture and the second compressed texture.
